(19) United States
(12) Patent Application Publication
(10) Pub. No.: US 2015/0257963 A1
(43) Pub. Date: Sep. 17, 2015

(54) Post-Pregnancy Hip Compression Garment

(71) Applicant: Jean Prahm, North Liberty, IA (US)

(72) Inventor: Jean Prahm, North Liberty, IA (US)

(21) Appl. No.: 14/209,545

(22) Filed: Mar. 13, 2014

(51) Int. Cl. A61H 1/00

(52) U.S. Cl. CPC A61H 1/008; A61H 2205/088

(57) ABSTRACT

A compression garment for compressing the hips to encourage the hips to re-position in pre-childbirth position or address sacroiliac dysfunction is provided. It includes an inner layer having at least one leg opening. The garment includes a compression band having a small portion permanently attached to the inner layer, and a first end and a second end. The band's first and second ends are detachably and adjustably tightened over the hips to selectively apply pressure. The band's ends may be secured to each other, or may be secured to the inner layer. Adjustments of pressure are made through hooks and eyes, ties and loops, buckles and straps, buttons or other mechanisms varying the relative positions of the ends of the band.

### PRIORITY INFORMATION

This application claims priority of U.S. Provisional Application No. 61/786,503 filed with the US Patent and Trademark Office on Mar. 15, 2013, the entire contents of which is herein incorporated by reference.

### FIELD OF THE INVENTION

This invention relates to post-pregnancy rehabilitation and in particular, to a garment worn by a woman after childbirth which creates a compression to the hip region encouraging loose hip joints to return to a pre-pregnancy position or even narrower.

### BACKGROUND OF THE INVENTION

The first few months following the birth of a child presents a time when a woman begins to see her body returning to her pre-pregnancy shape. For many women, the changes that occurred during pregnancy in the widening of the hip bones become permanent due to a relaxing of the ligaments which support the hip bones. Many new mothers, are unable to fit into their pre-pregnancy clothes due to widening of the hips, even after pre-pregnancy weight has been achieved. The invention allows for a specially designed compression garment that within weeks of wearing will result in shortened ligaments and smaller joint areas including the sacroiliac joint, and the pubis symphysis.

Compression garments have been commonly used post-operative following surgeries to reduce swelling, shorten recovery, and shrink skin. They have also been used to create the illusion of a “thinner” or “smoother” appearance.

Known compression garments consist of a fiber count fabric composition that provides support and elasticity. For instance, a number of compression garments are constructed from approximately 80% nylon and 20% elastic fabric. This fabric is known to be breathable allowing for the dissipation of heat and the transfer of moisture away from the body. However, the garments typically only work as compression garments without providing directional stability or directional compression.

Known compression garments that provide directional stability are typically designed to shape the body. For example U.S. Pat. No. 3,752,164 issued to Playtex Corporation discloses a compression garment providing multiple-region abdominal control. This garment forms a girdle with vertically distensible spaced apart lines of “zig zag stitching” which helps resist horizontal stresses. 0006 U.S. Pat. No. 6,062,946 disclosed a therapeutic garment for post-pregnancy use which is intended to keep loose skin/tissue/muscle firmly pressed against the lower abdomen only.

U.S. patent application Ser. No. 12/719,568 discloses an adjustable pelvic compression belt for reducing the user's hips post-parturition. While the pelvic belt seeks to achieve a similar goal as this invention. The pelvic belt application describes a belt that is less than 5 inches in height, and not a compression garment or “short.” The belt sits at or below the iliac crest, and is prone to displacement since its described placement is confined to a very mobile area of the body,

What is lacking in prior art is a compression garment for use in post-pregnancy that focuses on the reduction in the width of a user's hips which commonly remain wide following the birth of a child. This invention is also unique in that it can provide constant and consistent pressure without displacement, and encompasses the entire hip region from above the iliac crest, enclosing the pubic area, to the mid-upper thigh area to achieve optimal compression of the hips.

### SUMMARY OF THE INVENTION

The invention allows for a specially designed compression garment that, typically within weeks of wearing post-pregnancy, will result in the reduction of the width of the user's hips. The compression garment is designed to gently compress the hip region comprised of the hip (coxal) bone, sacrum, sacroiliac joint, and the pubic symphysis.

A method for reducing the width of a user's hips is achieved through a compression garment or “short” that will be utilized during the first 12 weeks following the birth of a child or to stabilize the sacroiliac joint for reduction of pain caused by sacroiliac joint dysfunction. This garment has two embodiments: one that begins just above the hips and continues to mid-thigh and a second that begins below the chest and continues to mid-thigh. The garment is designed to be worn like one would wear shorts and is used by stepping into at least one of two leg openings and pulling the garment upward until its lower edge rests about mid thigh and its upper edge is located either just above the hips, or just below the chest, depending on the embodiment employed.

The garment includes an inner layer comprising the leg openings, leg portions, and a girdle portion and an outer layer comprising a band which may be comprised of a single piece or several, has a first end and a second end, and that is secured in at least one place to the girdle portion. Both the inner layer (girdle portion) and the outer layer (band) provide compression with the inner layer providing compression to the body over all the areas it covers, and the outer layer providing additional, targeted compression over the area of the body that it covers directly, in this instance, the hip bones.

One embodiment includes an inner layer of a compression material which may be a nylon elastic blend, In some embodiments this inner layer is provided with stitching placement that supports directional compression of the hips and abdominal region. An embodiment includes an outer layer that may be comprised of a durable, flexible compression material such as a neoprene fabric, The inner and outer layers may be made of the same material. The inner and outer materials may be made of different materials.

The placement of the outer layer relative to the inner layer provides additional and directional compression to the hip region. The compression level of the outer layer may be adjusted by means to selectively increase tension through adjustable means of securing the first end and the second end. The adjustment means may be plural and may operate to associate the first and second ends together, or may operate to associate the first end with the inner layer, and the second end with the inner layer, either at or about the same position on the inner layer, or at differing positions. The first and second ends are generally equidistant from a mid-portion of the outer layer, however, another embodiment includes a band that is intended to be secured via overlapping the first and second ends, Overlapping may be accomplished by equi-distant first and second ends, or by ends unequal distances from the mid-portion. Means to adjust may include any one or several means such as zippers, hooks and eyes, buckles, Velcro®, straps. Adjustment means and levels of tension or pressure can be selected in accordance with the level of compression desired, That level may increase or decrease over time,

The combination of the inner layer and leg openings with the outer layer, and the association of the two together, provides precise placement and stable positioning relative to the hip bones. Unlike prior art similar devices, the outer layer is anchored in place relative to the inner layer by the securement to the inner layer in at least one place, and the girdle portion which is stably positioned by the leg portions or leg openings.

Because the hormones relaxin and progesterone are generally present at elevated levels in an individuals system during the 6-8 weeks post-pregnancy, the ligaments, joints, and connective tissue in the pelvic girdle remain pliable. The pressure exerted on the pelvic girdle by the invention compresses the hipbones to move together, thereby reducing the gap in the pubic symphysis as well as the sacroiliac joints. As relaxin and progesterone slowly return to normal levels post-pregnancy, the pelvic girdle strengthens and stabilizes the hips, and will remain reduced.

The invention may also serve as a method for reducing the width of a user's hips for any individual wishing to reduce their hip width who may believe that widening is due to loosening of the pubic symphysis and/or sacroiliac joints. Since relaxin and progesterone naturally occur at varying levels for different people, it is possible that there are some who could benefit from the invention who have not recently given birth (there is still a great deal to be learned about these hormones).

Relaxin is a polypeptide hormone with a similar structural identity to insulin. Relaxin affects collagen metabolism, inhibiting collagen synthesis and enhancing its breakdown by increasing matrix metalloproteinase's. It is produced mainly by the corpus luteum, in both pregnant and non-pregnant females. It rises to a peak within approximately 14 days of ovulation and then declines in the absence of pregnancy resulting in menstruation. During the first trimester of pregnancy levels rise and additional relaxin is produced due to the fetus. Relaxin's peak is reached during the 14 weeks of the first trimester and at delivery. Relaxin has a number of potential biological functions and has been shown to play a significant role in softening connective tissue in the pubic symphysis and cervix in preparation for birth of the fetus. After delivery, relaxin levels gradually dissipate for the next six to eight weeks and loosened pelvic joints and ligaments begin to tighten and stabilize.

### DESCRIPTION OF THE DRAWINGS

For a more complete understanding of the present invention, and the advantages thereof, reference is now made to the following descriptions taken in conjunction with the accompanying drawings, in which:

FIG. 1 is an illustration of the female pelvic girdle, including the sacrum, the coccyx, and the hip bones;

FIG. 2 is a front view illustration of the adjustable hip compression garment on a female's body;

FIG. 3 is a rear view illustration of the adjustable hip compression garment on a female's body;

FIG. 4 is a side view illustration of the hip compression garment on a female's body;

FIG. 5 is an angled top view illustration of the hip compression garment;

FIG. 6 is a plan view of an inside of an outer layer.

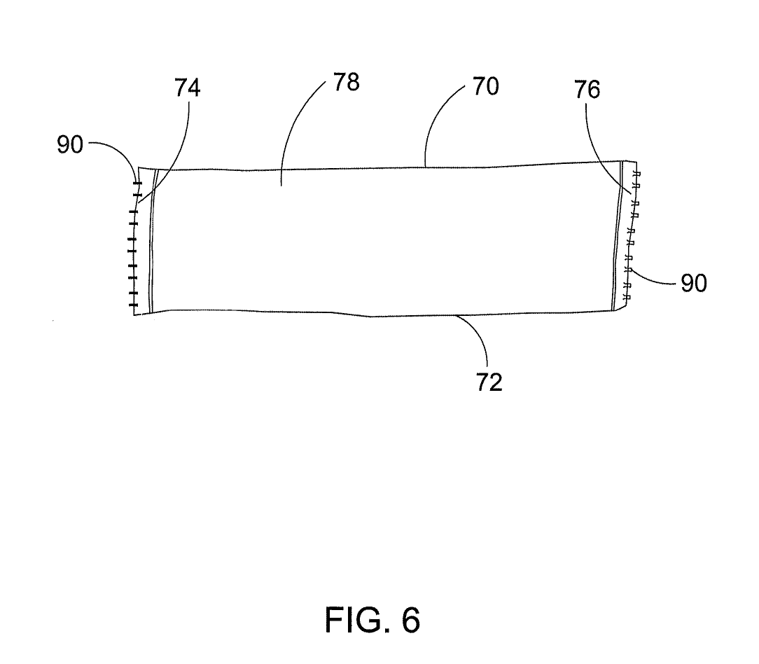

### DESCRIPTION OF THE PREFERRED EMBODIMENTS

Embodiments of the invention are directed to improved methods and systems for narrowing hips post-pregnancy and, more specifically, in the application of a hip compression garment or “short” during a period in which the hormone relaxin is likely present at heightened levels in the body. In addition, references to hip reduction and other terms used herein may be applicable to periods other than during post-pregnancy should it be determined that there are other instances or times in an individuals life where the benefits of hip reduction using this product could be attained.

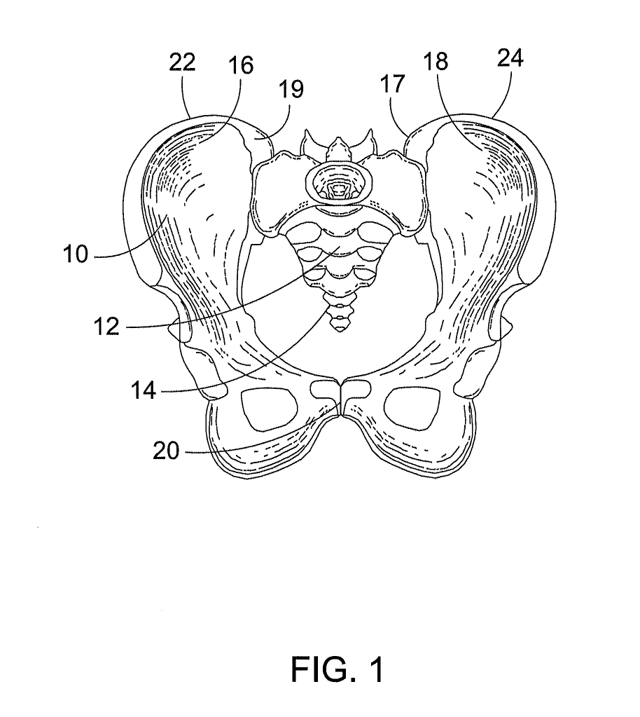

Referring to FIG. 1 showing aspects of the female pelvic girdle 10, sometimes called the pelvic ring, the hip girdle or the coax girdle, which connects the spine to the femurs. In the adult human, the pelvic girdle 10 is formed in the back by the sacrum 12 and the coccyx 14, and laterally and posteriorly by the right ilium 16 and the left ilium 18. At the top of the right ilium 16 is the right iliac crest 22 and at the top of the left ilium 18 is the left iliac crest 24. The right ilium 16 and the left ilium 18 are connected to each other anteriorly at the pubic symphysis 20, and posteriorly to the sacrum 12 at the sacroiliac joints 17 and 19. Because the pelvic girdle 10 is instrumental in transmitting loads from the trunk to the lower limbs, it is generally very stable and has very little mobility.

The right ilium 16 and the left ilium 18 are joined at the pubic symphysis 20, a non-synovial amphiarthrodial joint. This joint is connected by fibrocartilage and may contain a fluid filled cavity with a center that is generally avascular. The ends of the right ilium 16 and the left ilium 18 are covered by a thin layer of hyaline cartilage which has a slimy mass with a firm consistency and considerable elasticity. The hyaline cartilage is attached to the fibrocartilage. Women have a greater thickness of the pubic symphysis which allows more mobility of the pelvic bones, thus providing a greater diameter of pelvic cavity during childbirth. In addition, during pregnancy, hormones such as relaxin allow the pelvic bones to be more flexible for delivery. In non-pregnant conditions, the gap of the pubic symphysis is 4-5 mm but, in pregnancy, there will be an increase of at least 2-3 mm. Therefore, a total width of up to 8 mm between the two ilium bones is considered normal for a pregnant woman. This natural extra gapping due to relaxation of the pelvic articulations, including the pubic symphysis, decreases following the delivery, although the supporting ligaments will take three to five months to regain stability.

The pubic symphysis is not the only connective structure affected by the elevated hormones during pregnancy. The right ilium 16, and the left ilium 18 are also connected to the sacrum 12 by the sacroiliac joints 17 and 19. These joints are also loosened due to the effects of relaxin and progesterone.

As previously described, the hormone relaxin assists with the softening of the connective tissue of the pelvic girdle and remains in the body for 6 to 8 weeks post parturition. Unless pressure is placed on the pelvic girdle pushing the right ilium 16 and the left ilium 18 together at the pubic symphysis, and sacroiliac joints, the fibrocartilage remains lax and the gap in these areas remains. This gap in the pubic symphysis and sacroiliac joints may cause a woman's hips to become wider after parturition than before. This widening of the hips is considered undesirable by some and is frequently dismissed by healthcare professionals unless the laxity of the pelvic girdle results in pubic symphysis dysfunction.

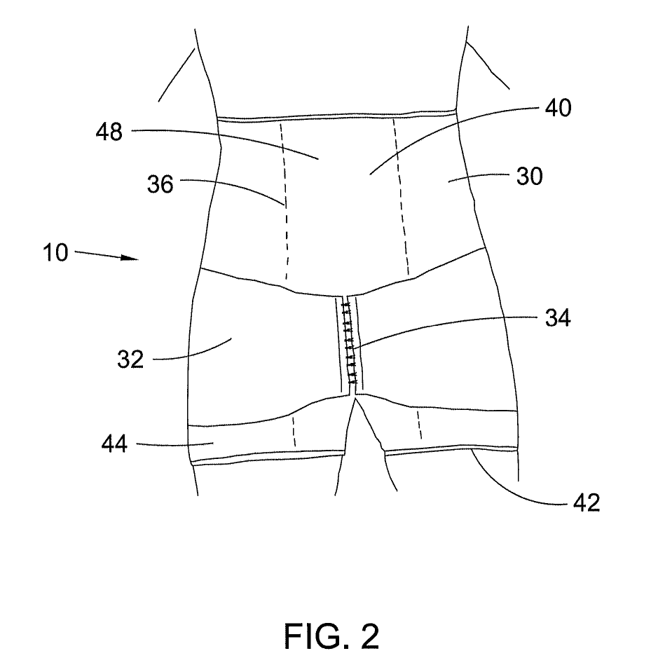

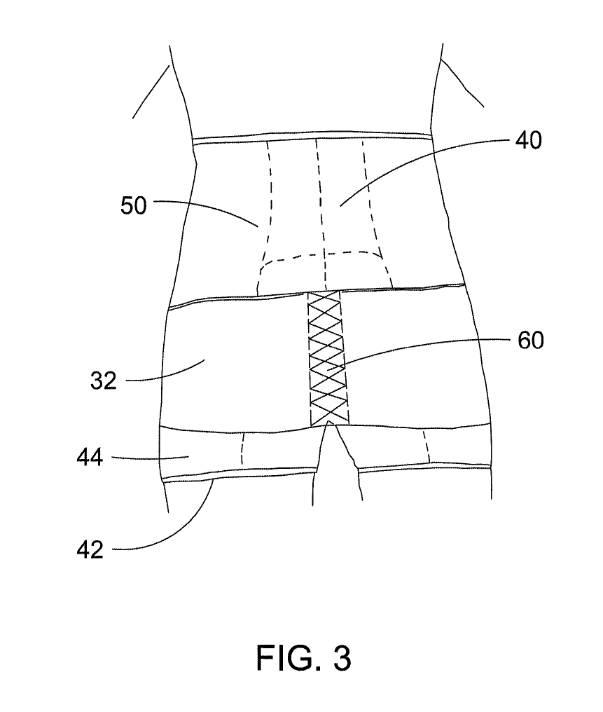

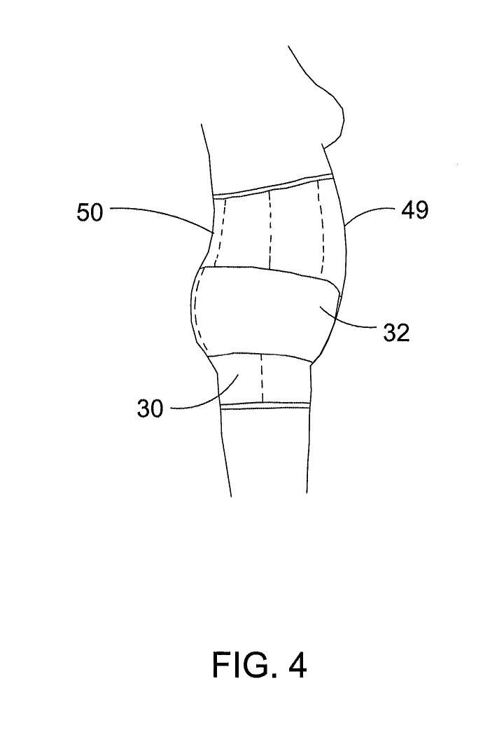

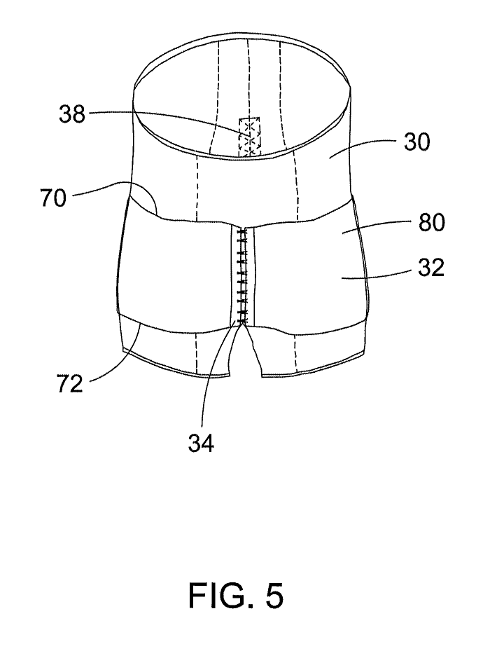

Referring to FIGS. 2-5, there is shown one embodiment of the hip compression garment 10 of the present invention. The garment 10 may include an inner layer 30 and an outer layer 32. The inner layer 30 may include stitching strategically placed 36 to provide directional compression. The inner layer comprises a girdle portion 40 having at least one leg opening 42 and, optionally, a leg portion 44. The girdle portion 40 may have two leg openings 42 and two leg portions 44 and an abdominal or trunk portion 48 having a front 49 and a back 50. The inner layer 30 is at least partially comprised of a compression material such as a 70% to 80% nylon, 20% to 30% lycra blend or any other material comprising adequate compression.

The outer layer 32 and the inner layer 30 are permanently associated by at least one place of connection 60. Said at least one place of connection 60 positioned at any point on the girdle portion 40. In one embodiment, the place of connection 60 is generally centered on the back 50 of the girdle portion 40. Said connection 60 may be accomplished via sewing, adhesive, or mechanical securements.

The outer layer 32 includes an upper edge 70, a lower edge 72, a first end 74, a second end 76, an inside 78 and an outside 80. The place of connection 60 locates and secures the outer layer's 32 position relative to the inner layer's 30 position. The first end 74 and the second end 76 are provided means to secure 90. Said means 90 may include hooks and eyes, string and eyelets, zipper, buckles, buttons, or a combination or any other means that will allow the first end 74 and the second end 76 to be secured one to another. In one embodiment said means to secure 90 includes a row of hooks on or near the first end 74 and a row of eyes on or near the second end 76. Alternatively, means 90 may facilitate associate of the first end 74 with the inner layer 30 and association of the second end 76 with the inner layer 30. Means 90 may be used to selectively add pressure to the right ilium 16 and the left ilium 18 together at the pubic symphysis and sacroiliac joints.

Means 90 may facilitate adjustment of compression level by allowing said first end 74 and said second end 76 to be secured together at any of several possible relative positions. In one embodiment this is accomplished by providing several rows of eyes on or near the second end 76, and a row of hooks on or near the first end 74, Alternatively, by employing ties and loops to provide adjustment alternatives by cinching the ties through the loops for more or less compression. An additional alternative may include a combination of securing the ends 74 and 76 together and then cinching them relative one another such as a plurality of ties on the first end 74 and a plurality of double rings on the send end, said ties placed and of a length allowing a variety of adjustments relative to pressure. Other embodiments include means for overlapping one end over the other and securing the two ends there; another embodiment includes means to secure on the first end, and inserting the first end 74 into a ring on the second end 76, and then securing the first end back to itself using securing means 90. The securing means of this embodiment may include a zipper, hooks and eyes, a buckle, buttons, Velcro or nearly any other means that may be used to detachably secure the first end of the outer layer back onto itself,

The band or outer layer 32 may be of any suitable width to provide adequate compression. The band 32 may be comprised of a plurality of sections connected together, The connection may or may not be at the place of connection 60; or may comprise sections associated with each other. Employing a plurality of sections provides means to incorporate materials of differing elasticity and compression for even more targeted application.

What I claim is:

1. A compression garment for providing compression to a wearer's hips comprising an inner layer and an outer layer, said inner layer comprising a girdle portion having at least one leg opening, and a material having a first level of compression, a portion of said inner layer permanently associated with a portion of said outer layer.

2. The compression garment of claim 1 wherein said outer layer comprises a first end, a second end, and a material having a second level of compression, said permanent association generally midway between said first end and said second end.

3. The compression garment of claim 2 wherein said first level of compression and said second level of compression are unequal.

4. The compression garment of claim 2 wherein said second level of compression is higher than said first level of compression.

5. The compression garment of claim 2 further comprising means to secure said first end relative to said inner layer and said second end relative to said inner layer.

6. The compression garment of claim 5 wherein said means to secure comprises a plurality of hooks and eyes.

7. The compression garment of claim 5 wherein said means to secure comprises a plurality of hooks positioned near one of said first end and said second end and a plurality of eyes positioned near the other of said first end and said send end.

8. The compression garment of claim 5 wherein said means to secure comprises adjustment means.

9. The compression garment of claim 8 wherein said adjustment means comprises placement of at least some of said means to secure spaced along a portion of the outer layer for associating at least one of said first end or said second end at any one of a plurality of positions along said portion.

10. The compression garment of claim 8 wherein said means to secure comprises a plurality of hooks and a plurality of eyes with at least a portion of the plurality of eyes spaced along a portion of the outer layer, and at least a portion of said plurality of hooks positioned on said inner layer.

11. The compression garment of claim 8 wherein said means to secure comprises at least one securement member positioned generally near said first end of the outer layer and at least one complimentary member positioned generally near said second end of the outer layer.

12. The compression garment of claim 11 wherein said at least one securement member comprises at least one tie and said complementary securement member comprises at least one loop for receiving said at least one of said ties.

13. The compression garment of claim 2, said permanent association comprising stitches securing said outer layer and said inner layer.

14. The compression garment of claim 2, said permanent association comprising adhesive applied between a portion of said outer layer and a portion of said inner layer.

15. The compression garment of claim 2, said girdle portion sized to end just below a wearer's chest and generally above the waist.

16. The compression garment of claim 2, said girdle portion sized to end at about the wearer's waist.

17. The compression garment of claim 5, said girdle portion comprising two leg openings and two leg portions.

18. The compression garment of claim 17, said means to secure comprising complementary securements associated with said first end and said second end for securing said first and second ends relative to each other and for selectively adjusting the level of compression exerted by said outer layer over said hips.
